(19) United States
(12) Patent Application Publication
(10) Pub. No.: US 2021/0018159 A1
(43) Pub. Date: Jan. 21, 2021

(54) LIGHTING SYSTEM FOR OUTDOOR LIGHTING

(71) Applicant: SIGNIFY HOLDING B.V., EINDHOVEN (NL)

(72) Inventors: Arno VREDENBORG, EINDHOVEN (NL); Joris Jan VREHEN, EINDHOVEN (NL)

(21) Appl. No.: 17/040,650

(22) PCT Filed: Mar. 29, 2019
(86) PCT No.: PCT/EP2019/058010

§ 371 Date: Sep. 23, 2020

(30) Foreign Application Priority Data
Apr. 3, 2018 (EP) 18165429.4

(51) Int. Cl. F21V 7/00; F21V 5/00

(52) U.S. Cl. CPC F21V 7/0091; F21W 2131/103; F21V 7/0083; F21V 5/007

(57) ABSTRACT

The invention provides a lighting system (1000) comprising (i) n lighting devices (100), wherein each lighting device (100) comprises a light source (10) configured to generate light source light (11) and m collimating beam shaping elements (120) configured to collimate the light source light (11) into collimated light source light (121), and (ii) a light transmissive optics arrangement (200) comprising an array (202) of k total internal reflection beam shaping elements (220), configured downstream of the m collimating beam shaping elements (120), wherein the light transmissive optics arrangement (200) is configured to receive the collimated light source light (121) and to transform into a divergent beam of lighting system light (1001), wherein n≥1, m≥n, and k≥3*m.

### FIELD OF THE INVENTION

The invention relates to a lighting system that may—amongst others—be used for outdoor lighting. The invention also relates to lamp comprising such lighting system. Such lamp may e.g. be used for outdoor lighting. The invention further relates to a method of lighting wherein the lighting system is applied.

### BACKGROUND OF THE INVENTION

The use of optics in luminaries for roadway lighting and other applications is known in the art. US2010/0073927, for instance, describes a lens for use with a solid-state light-emitting device, typically a light-emitting diode. The lens may be used in luminaries for roadway lighting and other applications. In one embodiment the lens includes a conical structure proximate the light-emitting source of the light-emitting device. This document especially describes a lens for use with a solid-state light-emitting device, the device having an axis, the lens comprising a substantially conically shaped light-transmitting element positioned proximate the solid-state light-emitting device, the light-transmitting element having a major axis substantially aligned with the axis of the solid-state light-emitting device, a profile formed on the light-transmitting element culminating in an apex pointing away from the solid-state light-emitting device when the light-transmitting element is positioned proximate the solid-state light-emitting device, the apex substantially coaxial with the axis of the solid-state light-emitting device.

EP0846914A1 discloses a lighting device comprising a reflector element and a screen provided with an array of lengthy, cylindrical micro lenses or microprisms, said microlenses or microprisms extending with their length over a major surface of the screen to render the lighting device to provide a batwing-like light distribution.

### SUMMARY OF THE INVENTION

It appears that road lighting distributions can effectively be generated from a combination of a refractive lens and high-power LED. Such combinations can be placed in arrays with a certain pitch between them such that the lenses are independent from each other. However, the visual appearance of such implementation, or the implementation known from the prior art, may be quite pixelated, as each LED can be observed individually. This pixelated appearance means that high peak luminances at the exit surface are alternating with low luminance regions. A high contrast between high and low luminance can be less comfortable for an observer looking at the luminaire compared to a surface area that has higher uniformity. The higher uniformity is favorable, also because it may lower the maximum of luminance.

Hence, it is an aspect of the invention to provide an alternative lighting system, or alternative lamp, which preferably further at least partly obviate one or more of above-described drawbacks. The present invention may have as object to overcome or ameliorate at least one of the disadvantages of the prior art, or to provide a useful alternative.

Amongst others, the invention proposes a LED array with collimation on top to produce parallel propagating light, in combination with a beam shaping texture that converts the collimated light into a functional road lighting distribution. This texture can consist of a single beam shaping element and multiple elements that all contribute to the final light distribution.

Hence, in a first aspect the invention provides a lighting system (“system”) comprising (i) n lighting devices (“device”), wherein each lighting device comprises a light source configured to generate light source light and at least one collimating beam shaping element (“collimators” or “collimating elements” or “collimator elements” or “collimating element” or “first elements”) configured to collimate the light source light into collimated light source light, (ii) in total m collimating beam shaping elements, and (iii) a light transmissive optics arrangement (“optics arrangement”) comprising an array of k total internal reflection beam shaping elements (“beam shaping elements” or “TIR elements”, or “second elements”), configured downstream of the m collimating beam shaping elements, wherein the light transmissive optics arrangement is configured to receive the collimated light source light and to transform in a beam of lighting system light, especially a divergent beam of lighting system light. Further, in specific embodiments n≥1, m≥n (especially m=n), and k≥m, especially k≥3*m, and wherein at least 25% of the total number of internal reflection beam shaping elements have a conical-like or pyramidal-like shape with tops.

With such system, in a relatively easy way beams can be provided that can be very broad, and which can e.g. be applied for street lighting (or “road lighting”). For instance, beams can be created that have a combination of a batwing shape of relatively high intensity with a specific amount of circular or faceted, ring shaped beam light surrounding the batwing pattern of a relatively low intensity, the relative intensities in dependency on the percentage of the internal reflection beam shaping elements have a conical-like or pyramidal-like shape that is combined with prismatic ridges on the light transmissive optics arrangement. For example, the batwing pattern is less pronounced with increasing percentage, for example at least 50% or 75% of the total number of internal reflection beam shaping elements have a conical-like or pyramidal-like shape. The fraction of internal reflection beam shaping elements that have a conical-like or pyramidal-like shape could also be expressed as an area fraction of the light transmissive optics arrangement covered by internal reflection beam shaping elements, i.e. said area fraction covered by internal reflection beam shaping elements that have a conical-like or pyramidal-like shape of the total area covered by internal reflection beam shaping elements is at least 25%, for example at least 40% or at least 60%. Further, with such system a relative even lighting surface can be provided, without the less desirable inhomogeneous intensity distribution in state of the art lamps.

Hence, amongst others the invention provides an optical solution to generate road lighting distributions that do not require any modifications to any other component of the existing luminaires. For instance, one may exchange a lens plate by the herein suggested optical solution without having to change anything else. The same PCB can be used, though one may end up with a different appearance. The present invention is a relatively simple solution with good result, whereas alternative optical solutions, like light guides or reflectors, require different positioning of the LEDs, which has impact on the luminaire architecture. The invention describes an optical solution that can be used with existing LED printed circuit boards, which consists of an array of LEDs spaced some observable distance apart. Further, a decoupling between the visual appearance (aesthetics) of the luminous surface and the optical performance is provided. The visual appearance is determined by the collimation of the LED sources. The optical performance is determined by the beam shaping structure. For instance, the collimating beam shaping elements and the optics arrangement may be a single (integrated) unit.

As indicated above, the invention provides a lighting system (“system”) comprising (i) n lighting devices (“device”) and (ii) a light transmissive optics arrangement (“optics arrangement”), wherein n≥1. Hence, the lighting system comprises at least a single lighting device, though especially, the lighting system may include a plurality of lighting devices. The lighting devices are especially configured in a 2D array, such as an a*b array, wherein a and b are each independently selected from the range of 2-10,000 (e.g. a 100*100 array), like 2-8,000, such as 4-4,000. However, even more may be possible.

Each lighting device comprises a light source configured to generate light source light and m collimating beam shaping elements (“collimators” or “collimating elements” or “collimator elements” or “first elements”) configured to collimate the light source light into collimated light source light. Note that the lighting device can be an integrated unit. In embodiments, the collimating beam shaping elements may also be provided as an integrated unit, which may e.g. be configured on a substrate with the plurality of light sources (e.g. a PCB).

Especially, the light source comprises a solid state light source. The term “light source” may refer to a semiconductor light-emitting device, such as a light emitting diode (LEDs), a resonant cavity light emitting diode (RCLED), a vertical cavity laser diode (VCSELs), an edge emitting laser, etc.. The term “light source” may also refer to an organic light-emitting diode, such as a passive-matrix (PMOLED) or an active-matrix (AMOLED). In a specific embodiment, the light source comprises a solid state light source (such as a LED or laser diode). In an embodiment, the light source comprises a LED (light emitting diode). The term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of semiconductor light sources may be configured on the same substrate (to form a light source or to form a plurality of light sources). In embodiments, a COB is a multi LED chip configured together as a single lighting module. The term “light source” may also relate to a plurality of light sources, such as 2-2000 solid state light sources.

The light source may be configured to generate white light. The term white light herein, is known to the person skilled in the art. It especially relates to light having a correlated color temperature (CCT) between about 2000 and 20000 K, especially 2700-20000 K, for general lighting especially in the range of about 2700 K and 6500 K, and for backlighting purposes especially in the range of about 7000 K and 20000 K, and especially within about 15 SDCM (standard deviation of color matching) from the BBL (black body locus), especially within about 10 SDCM from the BBL, even more especially within about 5 SDCM from the BBL. However, the light source may also be configured to generate colored light. Especially, the light source is configured to generate visible light, i.e. light having one or more wavelengths in the range of 380-780 nm. Especially, the light source is configured to generate light source light having an essentially Lambertian distribution.

The term “light source”, singular, may refer to all light sources of the system. Note that in embodiments different types of light sources may be applied, see also below.

Further, in embodiments the light source may be configured to generate tunable light source light. In such embodiments, the lighting system may include or may be functionally coupled to a control system, configured to control the light source. Further, when a plurality of light sources is available, two or more different light sources may be configured to provide light source light with different optical properties. In such embodiments, the lighting system may include or may be functionally coupled to a control system, configured to control the light sources. Further, when a plurality of lighting devices is available, two or more different lighting devices may be configured to provide lighting device light with different optical properties. In such embodiments, the lighting system may include or may be functionally coupled to a control system, configured to control the lighting devices. In such embodiments, one or more of the color, color temperature, color rendering index, etc. may be controllable.

In addition to the light source, the lighting device comprises a collimating element. Hence, the collimating element is configured in a light receiving relationship with the light source. However, in other embodiments the light source may also be optically coupled to a plurality of collimating elements; i.e. a plurality of collimating elements is configured in a light receiving relationship with the light source. Therefore, m is at least n. Hence, in embodiments m=n and in other embodiments m>n. The collimator has an optical axis which may essentially coincide with an optical axis of the lighting device. The light source may especially be configured close to or at a focal point of the collimator.

Especially, the collimator is thus configured to collimate the light source light. Hence, the light source light may e.g. have a Lambertian distribution. However, due to the configuration with the collimator, the light source light downstream of the collimator element may be collimated. In this way, the total internal reflection beam shaping elements receive light source light with rays that may essentially be configured parallel (and parallel to the optical axis of the lighting device). Hence, the light source light upstream of the total internal reflection beam shaping element(s) has a much lower degree of collimation than the light source light downstream of the total internal reflection beam shaping element(s).

The terms “upstream” and “downstream” relate to an arrangement of items or features relative to the propagation of the light from a light generating means (here the especially the light source), wherein relative to a first position within a beam of light from the light generating means, a second position in the beam of light closer to the light generating means is “upstream”, and a third position within the beam of light further away from the light generating means is “downstream”.

Different options may be chosen to provide the collimation. In specific embodiments, the collimating beam shaping element comprises one or more of a collimator, a TIR collimator, a concave reflector, a refractive lens, and a Fresnel lens. In embodiments, a Fresnel collimator, a TIR Fresnel lens, or a TIR collimator may be applied. A TIR Fresnel lens has a Fresnel operation on the TIR part of the collimator. Herein, the term “one or more” may include embodiments wherein two or more separate optical elements are configured as collimators, or are together configured as collimator, but may also refer to embodiments wherein a single body includes two or more of these optical elements (i.e. includes the functionalities of two or more of these optical elements), which is configured as collimator.

Especially, the beam shaping element comprises either a TIR collimator or a Fresnel lens. However, the collimator and Fresnel lens may also be combined in a single optic body. Further, the collimator may be a hollow body or a solid body. The light source may be configured in a collimator cavity, such as of a hollow reflector. The light source may also be configured in a cavity of a solid collimator body. The concave reflector may be a parabolic reflector. The collimating beam shaping element may also comprise a grid structure such as described in WO2017/182370.

As indicated above, the light source light may also be distributed over a plurality of collimator elements, such as over a plurality of Fresnel lenses, such as in embodiments wherein m>n. Especially, n≤m≤16*n, even more especially m=n. However, as a light source may consist of a plurality of light sources (“array type light source), such as a COB, in embodiments one or more light sources of the plurality of n lighting devices may (each) comprise a plurality of solid state light sources. Hence, the term “light source” especially refers to those one or more light emitting elements, that may together be considered as essentially a single light source, and of which at least part of the light source light, especially essentially all light source light, is received by the collimating beam shaping element.

The lighting system further comprises a light transmissive optics arrangement comprising an array of k total internal reflection beam shaping elements (“beam shaping elements” or “IR elements”, or “second elements”), configured downstream of the m collimating beam shaping elements, wherein especially and k≥m, more especially k≥3*m. Hence, downstream of the lighting device, an optics arrangement is configured.

Such optics arrangement may in embodiments be configured as a plate, especially when a plurality of lighting devices is available (in the system). The optics arrangement is not necessarily planar on a macroscopic scale (i.e. not taking into account the relatively small total internal reflection beam shaping elements). However, in embodiments the optics arrangement may essentially be planar. In other embodiments, the optics arrangement may be one or two dimensionally curved.

The optical axis of the lighting device or the optical axes of the lighting devices are especially configured essentially perpendicular to the optics arrangement.

The total internal reflection beam shaping element may especially be configured in a light receiving relationship with the lighting device. Hence, the optics arrangement is optically coupled with the lighting device. Especially, there is a plurality of total internal reflection beam shaping elements which gives a relative even appearance of the downstream side of the optics arrangement. Further, the distribution of the light may be more even, as instead of n light sources, the plurality of total internal reflection beam shaping elements may have a function as virtual light sources. Therefore, especially k≥m, more especially k≥3*m. Even more especially, k≥9*m. This may provide an even more even distribution. Indications like “k≥3*m” and similar indications especially indicate that each lighting device is optically coupled to at least 3 total internal reflection beam shaping elements.

The light transmissive optics arrangement is configured to receive the collimated light source light and to transform in a beam of lighting system light, especially a divergent beam of lighting system light. With the total internal reflection beam shaping elements, the beam can be shaped into a very broad beam, with relatively high intensities at large angles. This may allow the use for e.g. road lighting or lighting of relatively large areas.

Dependent upon the desired beam shape of the lighting system light, the shapes of the total internal reflection (TIR) beam shaping elements may be chosen. Further, the TIR beam shaping elements do not necessarily all have the same shape. Also two or more different types of TIR beam shaping elements may be applied. In general, the TIR beam shaping elements have a (virtual) base and an apex, wherein the apex is directed away from the lighting device(s).

Hence, the elements may especially include tapered elements. The elements especially taper in a direction from the (virtual) base to the apex. The tapering may be symmetrical for a sub-group of the TIR beam shaping elements or for all TIR beam shaping elements, such as centro symmetrical, or with mirror planes parallel to an element axis perpendicular to the (virtual) base, such as in the cases of conical or pyramidal shapes. However, for a sub-group or for all TIR beam shaping elements the tapering may also be non-symmetrical. For instance, the TIR beam shaping element may have only a single mirror plane.

The tapered elements may include a single circumferential face, such as in the case of a cone, or may include a plurality of faces, which faces bridge the distance between the (virtual) base and the apex, such as in the case of a pyramid.

The face(s) connecting the (virtual) base and the apex may be straight, faceted or curved (in a direction from the base to the apex), especially such face(s) includes a curvature. Such face(s) may also include a part that is straight and a part that is curved. In yet other embodiments, the side face(s) are especially straight over essentially the entire height of the internal reflection beam shaping elements. Hence, the face(s) may be curved in a direction parallel to the virtual base, such as in the case of a cone, or may be flat, such as in the case of a pyramid. Further, the faces may be flat (also indicated as “straight” or “linear”) in a direction from the base to the apex, such as in the case of a cone or pyramid, or may be curved. Hence, the face(s) may be 1D or 2D be flat and/or the face(s) may be 1D or 2D be curved. Also part of a face may be flat and another part of the same face may be curved. Especially, the face(s) thus include at least a part that is flat.

Hence, in embodiments the total internal reflection beam shaping element may include a curved segment, which includes at maximum 30%, such as at maximum 20% of the height of the total internal reflection beam shaping element. The optional curved segment is closer to the (virtual) base, then a linear segment. The total internal reflection beam shaping element at least comprises a linear segment. The linear segment includes especially at least 50%, such as at least 70% of the height of the total internal reflection beam shaping element. Optionally, at the top, there may be a second optional curved segment, which includes at maximum 10%, such as at maximum 5% of the height of the total internal reflection beam shaping element.

In embodiments essentially all the total internal reflection beam shaping elements have a conical-like or pyramidal-like shape with tops. Essentially all in this respect means 95% or more, such as 98% or 100% (=all) of the total number of TIR beams shaping elements. Herein the terms “conical-like” or “pyramidal-like” and similar terms may be applied, as the elements may have a conical shape or a pyramidal shape, or a shape similar to conical or a shape similar to pyramidal. Also hybrid shapes may be possible, such as a pyramidal like shape with curved faces. Hence, the elements may be facetted; the facets may be flat or may be curved. Especially, the internal reflection beam shaping elements have near-conical shape, but possibly pyramidal. Hence, the internal reflection beam shaping elements may have an essentially conical shape.

The tops of the total internal reflection beam shaping elements may in embodiments be rounded. Such rounding may be obtained with a typical manufacturing process. The top radius may e.g. be in the order of 0.01-1 mm, especially in the order of 0.05-0.2 mm. The top does essentially not have internal reflection, only refraction. It may be advantageous to have a small top radius as this leads to light at zero degrees, which is typically small in an outdoor light distribution. The rounding, i.e. the radius, may vary over the top. In yet other embodiments, the tops may be sharp.

Especially, the apex includes one or more angles in the range of 57.5-75°. Hence, in embodiments one or more tops, especially a plurality of tops, more especially essentially each top has a full top angle (β) selected from the range of 57.5-75°, especially selected from the range of 60-72.5°, yet more especially selected from the range of 62.5-70°. Different cross-section of the total internal reflection beam shaping element (parallel to the optical axis) may have the same or may provide different full top angles. In other words, a line connecting the optical axis and the face(s) may have different lengths (at the same height), when at different positions at the face(s) (at the same height).

The apex angle or full top angle may be defined as the angle between two straight lines that connect the top of the total internal reflection beam shaping element and the (virtual) base, wherein the end positions of such straight lines at the (virtual) base are at opposite parts at the virtual base, with the width, or length, or diameter as distance. The beam shaping elements are herein also indicated as “total internal reflection beam shaping elements”. The configuration and shapes of these elements are especially selected such, that when a substantial part of the collimated light source light entering the element exits the (conically shaped) element after the light is internally reflected (at least once) at the (curved) face of the (conically shaped element). Hence, when a light ray is propagating from the (virtual) base in direction of the apex, and hits one side of the tapered element, the light ray may be reflected and be directed to an opposite part of the tapered element, and escape after refraction from the element. Hence, the elements are indicated as “total internal reflection beam shaping elements”.

Hence, the elements are essentially configured as total internal reflection beam shaping elements and not as essentially refractive elements, as the total internal reflection beam shaping elements, as defined herein, are configured (and arranged) such that an essential part of the light source light that enters the total internal reflection beam shaping elements is first total internally reflected and then, at least part thereof, even more especially a substantial part thereof, is refracted at another part of the total internal reflection beam shaping elements, and escapes therefrom. For instance, at least 90%, such as least 95% of the (visible) light entering the total internal reflection beam shaping elements is first totally internally reflected, and at least part thereof, such as at least 50%, such as at least 80%, is then at another part of the face(s) of the total internal reflection beam shaping elements, refracted. For instance, in a light guide there are typically many total internal reflections, but that is not the case in the present invention. However, at the first reflection essentially all the light is still within the total internal reflection beam shaping elements and therefore it is a total internal reflection. With essentially refractive elements, it appears that the maximum width of the beam is much smaller than when total internal reflection beam shaping elements are applied, such as with the above-mentioned full top angle (β) or apex angle.

The total internal reflection beam shaping elements are relatively small. They may have dimensions similar or smaller than those of the light source(s). Further, they especially have dimensions substantially smaller than the collimating beam shaping elements. In specific embodiments, the total internal reflection beam shaping elements have one or more dimensions selected from the group consisting of a base width (w), a base length (l), a base diameter (d), and an element height (h), wherein one or more of these dimensions are selected from the range of 0.02-10 mm, especially selected from the range of 0.2-8 mm, such as 1-6 mm. Instead of the dimensions base width (w), a base length (l), a base diameter (d), also the dimension equivalent circular diameter may be used (which is thus especially in the indicated range(s)). The equivalent circular diameter (or ECD) of an irregularly shaped two-dimensional shape is the diameter of a circle of equivalent area. For instance, the equivalent circular diameter of a square with side a is 2*a*SQRT(1/π). Hence, in specific embodiments the total internal reflection beam shaping elements may have one or more dimensions selected from the group consisting of a base equivalent circular diameter (d) and an element height (h), wherein one or more of these dimensions are selected from the range of 0.02-10 mm, especially selected from the range of 0.2-8 mm, such as 1-6 mm.

In view of the relatively small dimensions, the collimated light source light of a single device is received by a plurality of total internal reflection beam shaping elements. Therefore, especially k≥3*n. Further, especially k≥3*m, such as at least 20 per collimating beam shaping element (i.e. k=20*m). Hence, a plurality of total internal reflection beam shaping elements are configured in a light receiving relations ship with a collimating beam shaping element. In principle, the number of total internal reflection beam shaping elements per lighting device may differ for two or more lighting devices.

As indicated above, in embodiments the lighting system may comprise a plurality of n lighting devices, which may especially be configured in an array. In specific embodiments, wherein n≥4 , such as n≥9, like at least 16, such as up to 2000. When a plurality of lighting devices, each lighting device may include one or more collimating beam shaping elements. However, in specific embodiments each lighting device includes a single collimating beam shaping element. Hence, in specific embodiments m=n.

The collimating beam shaping elements and the total internal reflection beam shaping elements are especially light-transmitting and are of a light transmissive material. Hence, at least part of the light source light is transmitted through the collimating beam shaping elements and the total internal reflection beam shaping elements. Hence, the optics arrangement is light transmissive. This especially implies that the arrangement comprises a (solid) material that is light transmissive. Likewise, the collimating beam shaping elements may comprise comprises a (solid) material that is light transmissive.

The light transmissive material may comprise one or more materials selected from the group consisting of a transmissive organic material, such as selected from the group consisting of PE (polyethylene), PP (polypropylene), PEN (polyethylene napthalate), PC (polycarbonate), polymethylacrylate (PMA), polymethylmethacrylate (PMMA) (Plexiglas or Perspex), cellulose acetate butyrate (CAB), silicone, polyvinylchloride (PVC), polyethylene terephthalate (PET), including in an embodiment (PETG) (glycol modified polyethylene terephthalate), PDMS (polydimethylsiloxane), and COC (cyclo olefin copolymer). Especially, the light transmissive material may comprise an aromatic polyester, or a copolymer thereof, such as e.g. polycarbonate (PC), poly (methyl)methacrylate (P(M)MA), polyglycolide or polyglycolic acid (PGA), polylactic acid (PLA), polycaprolactone (PCL), polyethylene adipate (PEA), polyhydroxy alkanoate (PHA), polyhydroxy butyrate (PHB), poly(3-hydroxybutyrate-co-3-hydroxyvalerate) (PHBV), polyethylene terephthalate (PET), polybutylene terephthalate (PBT), polytrimethylene terephthalate (PTT), polyethylene naphthalate (PEN); especially, the light transmissive material may comprise polyethylene terephthalate (PET). Hence, the light transmissive material is especially a polymeric light transmissive material. However, in another embodiment the light transmissive material may comprise an inorganic material. Especially, the inorganic light transmissive material may be selected from the group consisting of glasses, (fused) quartz, transmissive ceramic materials, and silicones. Also hybrid materials, comprising both inorganic and organic parts may be applied. Especially, the light transmissive material comprises one or more of PMMA, transparent PC, or glass. In specific embodiments, the light transmissive optics arrangement comprises one or more of polymethyl methacrylate (PMMA) and polycarbonate (PC) total internal reflection beam shaping elements.

When a plurality of lighting devices is applied, especially more than 3, such as at least 9, at least 20 or at least 40 up to for example 200 or up to for example 1000, the lighting devices may be configured in a regular array or an irregular array. Also a hybrid arrangement may be chosen, such as a pseudo-random arrangement, like a phyllotaxis arrangement, a Fermat's spiral arrangement or a (multiple) Fibonacci spiral arrangement. Typically lighting system with these “natural” pattern arrangement of lighting devices provide an even more uniform and highly appreciated, less patterned beam profile. The higher number of lighting devices, the better the natural patterns can be mimicked, but a number of at least 20 is preferable.

Alternatively or additionally, the total internal reflection beam shaping elements may be configured in a regular array or an irregular array. Also a hybrid arrangement may be chosen, such as a pseudo-random arrangement, like a phyllotaxis arrangement. Therefore, in embodiments the array of total internal reflection beam shaping elements may comprise a random or pseudo-random arrangement of the total internal reflection beam shaping elements. Hence, even when the lighting devices would be configured in a regular array, which may in general be the case (when using a plurality of lighting devices), the total internal reflection beam shaping elements may be configured in an irregular array hybrid arrangement may be chosen, such as a pseudo-random arrangement, like a phyllotaxis arrangement. Hence, in specific embodiments the array of total internal reflection beam shaping elements comprises phyllotaxis arrangement of the total internal reflection beam shaping elements. With an irregular or hybrid arrangement, the appearance of the light emissive surface, whether the system is in the off-state or on-state may appear more natural and may therefore also less be distracting the attention of viewers.

A phyllotactic arrangement (or phyllotaxis arrangement), which is based on the Fibonacci sequence, or “golden ratio”, is an arrangement that often occurs in nature. An advantage of this arrangement is that the arrangement does not consist of straight lines of light sources in any direction, and the arrangement is not a messy, random one either. It is a very natural arrangement (as it occurs in nature in sunflowers, dandelions, pine cones etc.). A random grid could be an alternative option, but a phyllotactic one seems most appreciated. Especially, the pattern is essentially phyllotactic. Therefore, in embodiments the arrangement of the plurality of beam shaping optics is a phyllotactic arrangement. The phyllotactic pattern may be described based on the pattern of florets (or seeds) in a sunflower head. These may be based on the formula: φ=p*137.5°, r=c*√p, wherein p is the ordering number of a floret, counting outward from the center. This is the reverse of floret age in a real plant, φ is the angle between a reference direction and the position vector of the p^{th} floret in a polar coordinate system originating at the center of the capitulum. It follows that the divergence angle between the position vectors of any two successive florets is constant, α=137.5°, and r is the distance between the center of the capitulum and the center of the nth floret, given a constant scaling parameter c. Translating this to the luminaire, p may be selected from the range of e.g. 24-800.

As indicated above, the arrangement of internal reflection shaping elements may also include a plurality of (different) arrangements. For instance, this may be used for creating a relative even intensity distribution of the system light. Therefore, in embodiments the system may comprise at least two types of differently sized beam shaping elements, wherein first beam shaping elements comprise the total internal reflection beam shaping elements, wherein sets of three or more total internal reflection beam shaping elements surround one or more second beam shaping elements. The one or more second beam shaping elements may be configured to further fill the intensity distribution to provide a more even distribution. For instance, a batwing shape may also be filled in the middle with intensity. In yet further specific embodiments, one or more second beam shaping elements also comprise total internal reflection beam shaping elements as defined herein, but having shapes and/or dimensions different from the first beam shaping elements.

Hence, in specific embodiments the lighting system is configured to generate a batwing shaped beam of lighting system light. More especially, the combination of first beam shaping elements and total internal reflection beam shaping elements may be configured to generate a batwing shaped beam of lighting system light. In yet other embodiments, the system may be configured to provide a modified batwing shaped beam of lighting system light.

In specific embodiments, the lighting system is especially configured to generate the beam of lighting system light with an optical axis (O), wherein at least 50% of a total intensity (in Watt) of the lighting system light is at an angle (α) of at least 50° relative to the optical axis (O). More especially, the combination of first beam shaping elements and total internal reflection beam shaping elements may be configured to generate the beam of lighting system light with an optical axis (O), wherein at least 50% of a total intensity (in Watt) of the lighting system light is at an angle (α) of at least 50° relative to the optical axis (O), like in the range of 50-90°, such as 50-85°

In yet further embodiments, the lighting system may further comprise or be functionally coupled to a control system, configured to control one or more of the intensity of the lighting system light, the spectral distribution of the lighting system light, and the spatial distribution of the lighting system light. Hence, especially such control system is configured to control light sources that have a tunable spectral distribution and/or to control two or more subset of light sources (wherein each subset at least comprises a single light source).

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc.. Beyond that, the term “controlling” and similar terms may additionally include monitoring. Hence, the term “controlling” and similar terms may include imposing behavior on an element and also imposing behavior on an element and monitoring the element. The controlling of the element can be done with a control system. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems.

The lighting system may be part of or may be applied in e.g. office lighting systems, household application systems, shop lighting systems, home lighting systems, accent lighting systems, spot lighting systems, theater lighting systems, fiber-optics application systems, projection systems, self-lit display systems, pixelated display systems, segmented display systems, warning sign systems, medical lighting application systems, indicator sign systems, decorative lighting systems, portable systems, automotive applications, (outdoor) road lighting systems, urban lighting systems, green house lighting systems, horticulture lighting, or LCD backlighting.

In yet a further aspect, the invention also provides a lamp comprising the lighting system as defined herein. Especially, the lamp may be an outdoor lamp.

In yet a further aspect, the invention also provides a method of illuminating an area, such as especially selected from the group of an outdoor open area, a square, a road, and a plant area, the method comprising providing lighting system light with the lighting system as defined herein or with the lamp as defined herein to the area. The term “road” herein may amongst others (also) refer to a way, a motorway, an avenue, an alley, a boulevard, a byway, a drive, an expressway, a highway, lane, a parking lot, a parkway, a passage, a pathway, a pavement, a pike, a roadway, a route, a street, a subway, a terrace, a thoroughfare, a throughway, a thruway, a track, a trail, a turnpike, a viaduct, etc. It especially refers to any entity on which a vehicle may propagate.

Especially, the light transmissive optics arrangement is configured parallel to the area that is to be illuminated, or under a small angle, such as at maximum about 30°, such as at maximum about 25°, like at maximum about 10°.

Yet further, in an aspect the invention also provides a computer program enabled to carry out the method as defined herein, for instance when loaded on a computer (which is functionally coupled to the lighting system or the lamp comprising the lighting system).

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c schematically depict some aspects;

FIGS. 2a-2d schematically depict some further aspects;

FIGS. 3a-3f schematically depict some variants and embodiments; and

FIG. 4 schematically depicts a further embodiment;

The schematic drawings are not necessarily to scale.

### DETAILED DESCRIPTION OF THE EMBODIMENTS

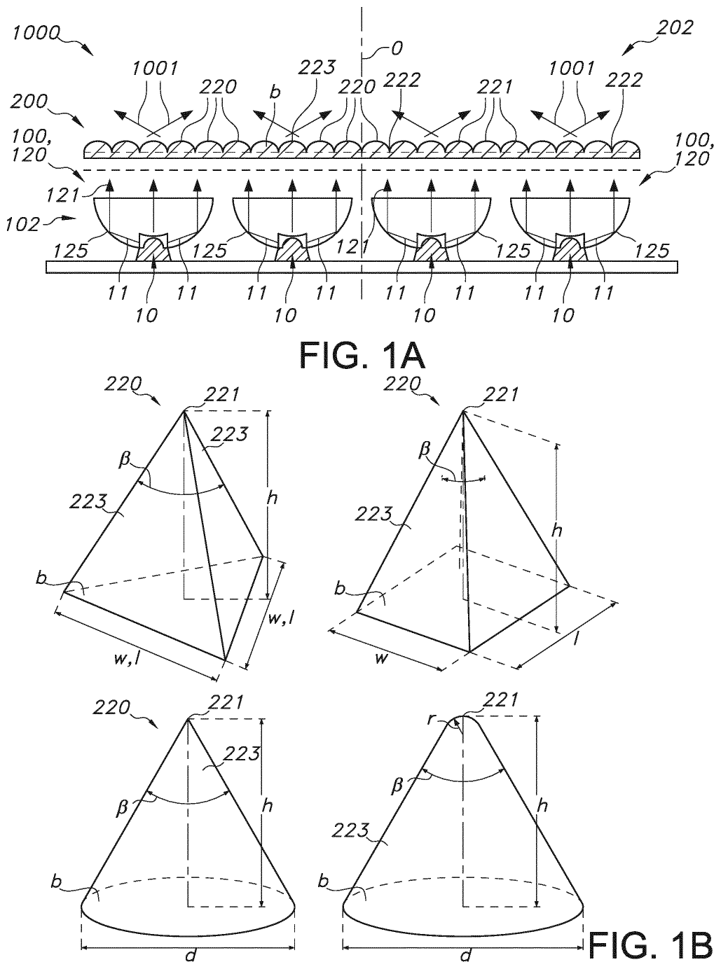

FIG. 1a schematically depicts and embodiment of a lighting system 1000. The lighting system 1000 comprises n lighting devices 100. Here, n=4 by way of example (or 4 rows of lighting devices 100 are provided, as FIG. 1a is in fact a cross-sectional view).

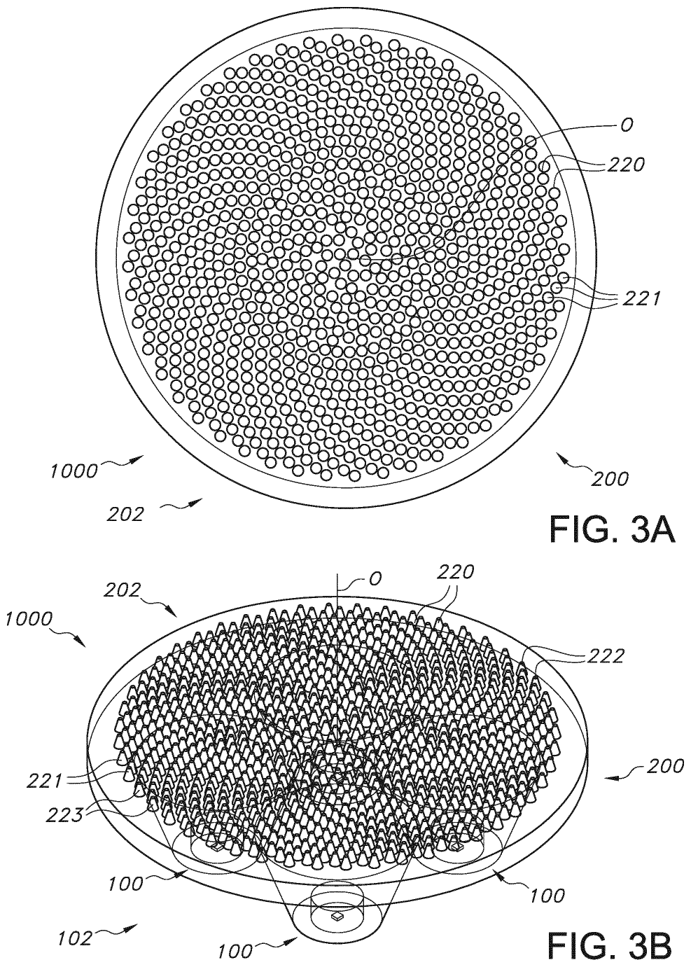

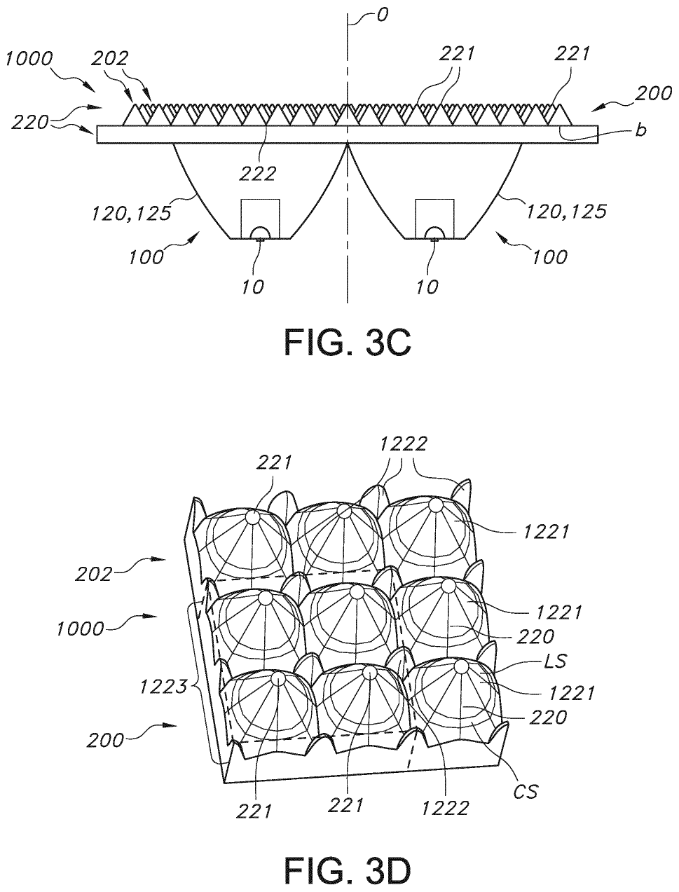

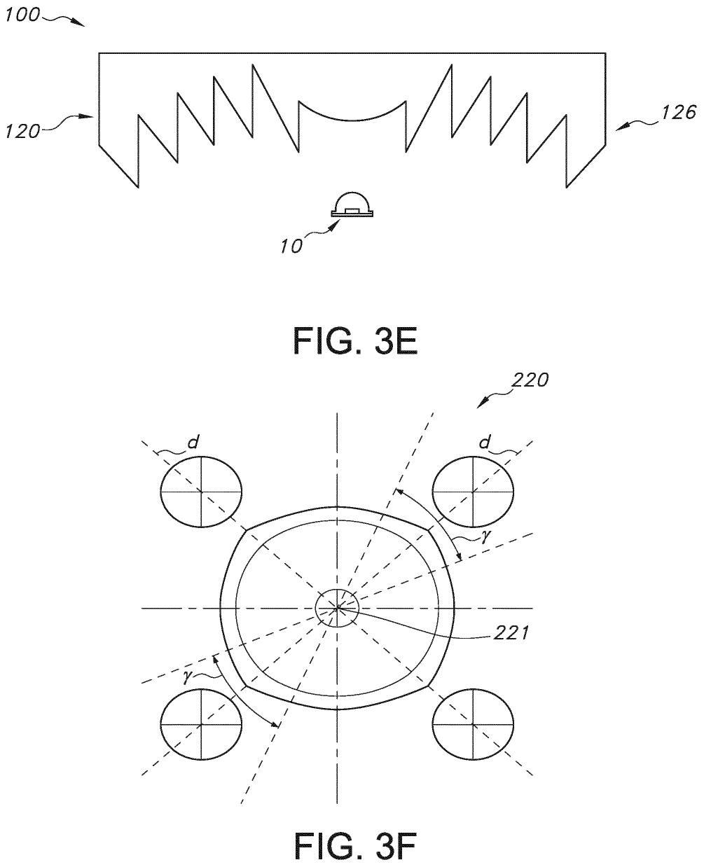

Each lighting device 100 comprises a light source 10, such as a LED, configured to generate light source light 11 and m collimating beam shaping elements 120 configured to collimate the light source light 11 into collimated light source light 121. Here, m=n. Further, here the collimating beam shaping element 120 comprise collimators 125. Fresnel lenses may also be used, see FIG. 3e.

The lighting device 1000 further comprises a light transmissive optics arrangement 200 comprising an array 202 of k total internal reflection beam shaping elements 220. Here, k is about 20. The optics arrangement 200 is configured downstream of the collimating beam shaping elements 120. The light transmissive optics arrangement 200 is configured to receive the collimated light source light 121 and to transform into a divergent beam of lighting system light 1001.

The total internal reflection beam shaping elements 220 have tops 221 and minima 222 between adjacent total internal reflection beam shaping elements 220. The total internal reflection beam shaping elements 220 have virtual bases b. Here, total internal reflection beam shaping elements 220 are part of a larger unit, such as a light transmissive plate. Hence, the virtual base can be defined as the plane between the minima between adjacent total internal reflection beam shaping elements 220. Reference 223 indicates the faces of the total internal reflection beam shaping elements 220. The light transmissive optics arrangement 200 may e.g. comprises one or more of polymethyl methacrylate and polycarbonate total internal reflection beam shaping elements 220. Reference O indicates the optical axis.

Hence, an embodiment of the lighting system is shown in FIG. 1a. The light from several LEDs is collimated and the beam shaping is performed at the exiting surface by a texture, where multiple texture elements can be positioned over a single LED. There is a virtual separation plane, where parallel light goes through. The exit surface luminance of the whole luminaire now becomes only dependent on the homogeneity of the flux going through this virtual plane. This in turn is dependent on the implementation of the collimator array. Subsequently, the beam shaping is done by the texture, where each element produces the final light distribution to a large extent, as to have a homogeneous appearance from all viewing angles.

The total internal reflection beam shaping elements 220 may in embodiments have a conical-like or pyramidal-like shape with tops 221. Examples are schematically shown in FIG. 1b, with from left to right a trigonal pyramid, a tetragonal pyramid, a cone, and a cone with a rounded top 221. However, other shapes, such as with more faces 223, may also be possible (see also FIG. 3d). references w, l, h, and d indicate the width, length, height, and diameter of the virtual base, respectively. These dimensions may be selected from the range of 0.02-10 mm. Especially, one or more of these dimensions are selected from the range of 0.2-8 mm, such as 1-6 mm. FIG. 1b on the right shows the radius r of a rounded top 221. Note that also the tops 221 of the pyramidal shapes may be rounded.

The total internal reflection beam shaping elements 220 have full top angles β which may essentially be the same over an entire cross-section (perpendicular to the axis (here the dashed perpendiculars, with height h)) for the conical embodiments. For the pyramid type element 220 shown at the right top, the full top angle β is the angle between two oppositely arranged faces 223. The oppositely arranged faces have at the base b a distance equal to the width w or length l.

Hence, as shown in FIG. 1b (and 2d), the apex angle or full top angle β may be defined as the angle between two straight lines that connect the top of the total internal reflection beam shaping element and the (virtual) base, wherein the end positions of such straight lines at the (virtual) base are at opposite parts at the virtual base, with the width, or length, or diameter as distance.

FIG. 1c very schematically depicts a lamp 1 comprising the lighting system 1000, which illuminates an area 2. A characteristic spectral distribution is depicted, here a batwing distribution, with main intensities at angles larger than α1 and smaller than α2. As indicated below, these angles are especially between about 65-80°. Hence, at least 50% of the intensity may be found between these angles with the optical axis O.

Therefore, in embodiments at least 50% of a total intensity of the lighting system light is at an angle α of at least 50° relative to the optical axis O, such as in the range of 50-90°, such as 50-85°.

Essentially all the area of optics arrangement 200 should be filled with internal reflection beam shaping elements 220, otherwise the collimated light may propagate without redirection towards zero degrees, which is typically not desired in batwing distributions. Square and triangular base are easy to connect together to fill the area. However, round bases may be intersecting with each other (which is not shown in the schematically depicted embodiment of FIG. 3a, as there is no overlap between the internal reflection beam shaping elements 220).

FIGS. 1a and 1c schematically show a divergent beam of lighting system light 1001.

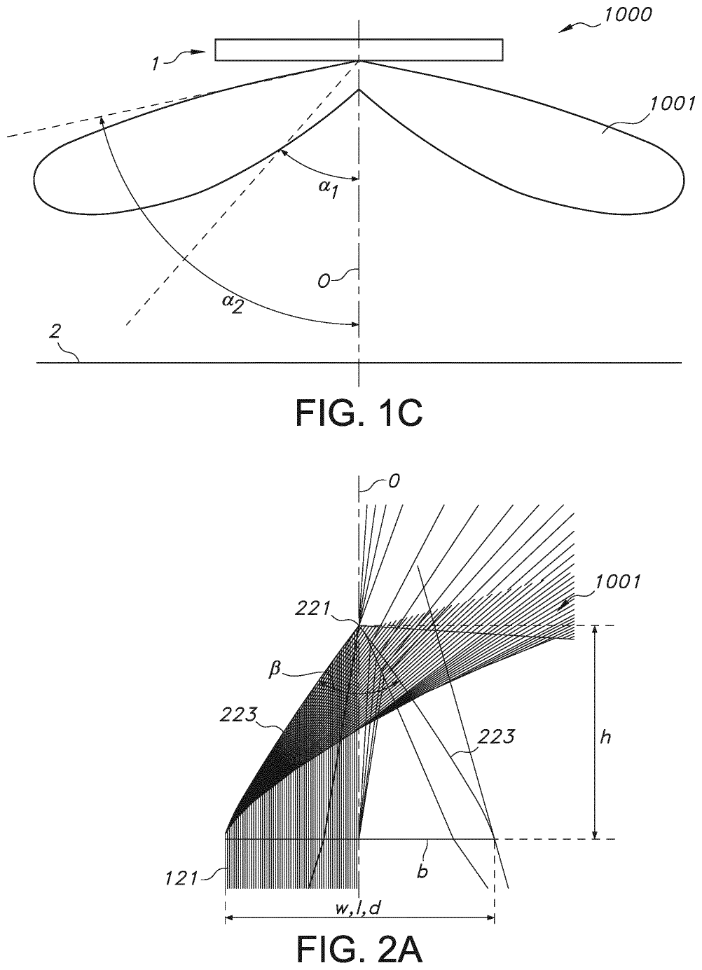

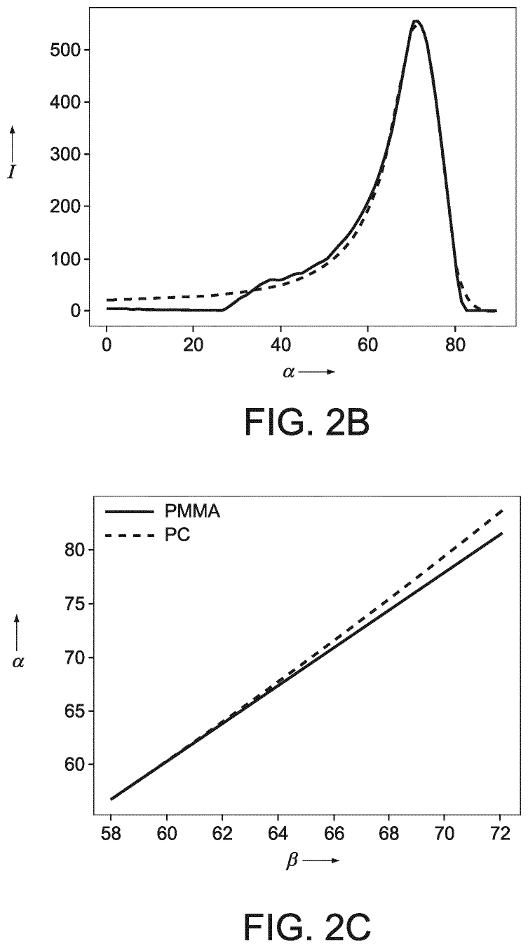

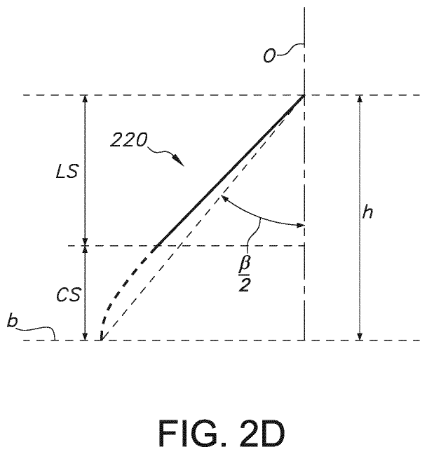

FIG. 2a schematically depicts a cross-section of such total internal reflection beam shaping element 220. As this cross-section can be the cross-section of a tetragonal pyramid, a trigonal pyramid, and a cone, the dimensions of the base are indicated with width w, length l, and diameter d. The dimensions of the base may also be indicated as equivalent circular diameter. Angle β is the full top angle β, which may especially be selected from the range of 57.5-75°. In FIG. 2a, the cone is slightly convex, but is nearly conical of shape. Using such total internal reflection beam shaping elements 220 may e.g. lead to an essentially rotational symmetric distribution have an angular intensity profile as schematically depicted in FIG. 2b. There appears to exist a relatively simple linear relation between the full cone angle and the peak angle of the distribution as shown in FIG. 2c. Typical desirable distributions have a peak between 65 and 80°, which makes a full cone angle of 62.5-70 degrees. There is a small difference between PMMA and Polycarbonate, which are the especially useful materials. Silicone may also especially be useful. In embodiments, the full top angle may vary over the (face(s) of the) total internal reflection beam shaping elements. For instance, in embodiments the total internal reflection beam shaping elements may have

FIG. 2a also shows that these elements 220 are not essentially refractive elements but internal reflection elements for these essentially collimated light rays provided by the collimating element (see also above). Hence, when a light ray is propagating from the (virtual) base b in direction of the apex or top 221, and hits one side 223 of the tapered element, the light ray may be (totally internally) reflected and be directed to an opposite part of the tapered element, and escape after refraction from the element. Hence, the elements are indicated as “total internal reflection beam shaping elements”.

FIG. 2d schematically depict in more detail embodiments of the internal reflection beam shaping elements 220, such as depicted in FIG. 2a or 3d. In FIG. 2d, a cross-section is shown, which typically has a cone at the top (=linear segment), with an inward curvature at some point towards the base of the geometry. The linear segment has a full top angle β that corresponds to the peak of the distribution. The curved segment is specific for producing intensity at angles smaller than the angle of maximum intensity. The difference in β angle between the linear segment and the curved segment at the bottom is clearly visible in FIG. 2d. Finally, there could be two (or more) different (vertical) cross-sections in a single texture element. The term “vertical cross-section” especially refers to a cross-section perpendicular to the (virtual base) and/or being parallel to e.g. a cone axis or being parallel to a perpendicular from the apex to the (virtual) base, such as shown in FIGS. 1b, 2a and 2d.

Hence, especially the total internal reflection beam shaping element 220 has a linear segment LS, which includes especially at least 50% of the height h of the total internal reflection beam shaping elements. Further, the total internal reflection beam shaping element may include a curved segment CS, which includes at maximum 30%, such as at maximum 20% of the height of the total internal reflection beam shaping element. The optional curved segment is closer to the (virtual) base b, then the linear segment. Optionally, at the top 221, there may be a second optional curved segment, which includes at maximum 10%, such as at maximum 5% of the height of the total internal reflection beam shaping element 220.

As shown in FIGS. 1b and 2d, in embodiments, the side face(s) are especially straight over essentially the entire height of the internal reflection beam shaping elements (see FIG. 1d). Hence, the face(s) may be curved in a direction parallel to the virtual base, such as in the case of a cone (see FIG. 1b, lower two embodiments, and FIG. 2d), or may be flat, such as in the case of a pyramid (see FIG. 1b, upper two embodiments. Further, the faces may be flat (also indicated as “straight” or “linear”) in a direction from the base to the apex (FIG. 1b (except upper top in the lower right embodiment), such as in the case of a cone or pyramid, or may be curved (part of the face of the embodiment schematically depicted in FIG. 2d). Hence, the face(s) may be 1D or 2D be flat and/or the face(s) may be 1D or 2D be curved. Also part of a face may be flat and another part of the same face may be curved. Especially, the face(s) thus include at least a part that is flat.

The internal reflection beam shaping elements 220 as schematically depicted in FIGS. 2a and 2d have a near-conical shape.

A feature of the invention is that it is now possible to arrange the optical element from FIG. 2a into an array 202 as shown in FIGS. 3a-3c. Especially, the element 220 may be configured in an irregular array 202, such as to maintain the rotational symmetry of the element. However, there are outdoor distributions that do not require rotational symmetry, and these allow for other layouts, e.g. a square grid, as well (see e.g. FIG. 3d). FIGS. 3a and 3b schematically depict beam shaping element 220 (of FIG. 2a) placed into an irregular (sunflower) array. Hence, the array 202 of total internal reflection beam shaping elements 220 comprises a random or pseudo-random arrangement of the total internal reflection beam shaping elements 220, such as comprising a phyllotaxis arrangement of the total internal reflection beam shaping elements 220.

Another feature is that the beam shaping elements 220 in the array 202 can have a physical dimension on the order of the LED or smaller. Preferably, the diameter of the geometry of FIG. 2a is on the order of 100 micrometer to several millimeters (<10 mm). Also referring to FIG. 1a, which shows multiple elements per LED. For example, four LEDs may be combined with total internal reflecting (TIR) collimators and the plate of FIG. 3a as shown in FIGS. 3b (perspective) and 3c (side view or cross-sectional view). Hence, FIGS. 3b-3c schematically depict embodiments of the lighting system 1000 comprising a plurality of n lighting devices 100 configured in an array 102, wherein n=4 and m=n.

Collimators as schematically depicted in FIGS. 1a and 3c may have one or more TIR parts but may alternatively or additionally also have one or more Fresnel parts. Further, all kind of shapes may be applied, or combinations of shapes.

Especially, the collimation and beam shaping texture are integrated into a single optical plate, see FIG. 3c. This leads to a minimal umber of material-air interfaces while each interface leads to optical losses. However, the plate may be separate from the collimation plate, see the geometry in FIG. 1a. Optionally, there may be a diffuser placed in between, that gives some beam spreading, which will lead to a loss of image formation by the optical system. This leads to less visible LEDs. Such diffuser may be configured to broaden the collimated light source light no more than 5° (relative to the optical axis of the system 1000).

A consequence of the array formation is that the optical elements are physically intersecting, which means that the light distribution per element becomes affected. The interference of the elements must be compensated for to maintain the required distribution. This can be done by combining multiple elements into a single plate, for example a design with multiple elements is shown in FIG. 3d. The cone structures from FIG. 2a are the main beam shaping elements and are cut out in a square pattern. Additional cones (with a top radius) are positioned at the corners of the squares to compensate effects caused by the interference of the main elements in the square pattern. The small cones redirect the light to where the light from the main cones is missing. Hence, FIG. 3d schematically depicts an embodiment of the lighting system 1000 comprising at least two types of differently sized beam shaping elements, wherein first beam shaping elements 1221 comprise the total internal reflection beam shaping elements 220, wherein sets 1223 of three or more total internal reflection beam shaping elements 220 surround one or more second beam shaping elements 1222.

Instead of a TIR collimator/reflector, such as schematically depicted in FIGS. 1a, 3b, and 3c, also a Fresnel lens 126 may be applied, see FIG. 3e.

FIG. 3f schematically shows an embodiment of total internal reflection beam shaping elements 220, such as shown in FIG. 3d (total internal reflection beam shaping elements 1221). Such total internal reflection beam shaping elements 220 may be configured in a square area. Along the diagonal(s) d (in the square array), the full top angle may be slightly larger than an average cone angle. The area with elevated cone angle may be defined with an angle γ, which may be at maximum about 45°, but especially not larger than 30°, such as 5-25°. Though all full cone angles may be within the defined range, the slight modulation of the cone angle, such as about 1-10°, such as 1-6°, may further allow shaping the beam shape. For instance, with the indicated modulation within the angles γ (of which only two are shown), a square or rectangular cross-shape of the beam may be obtained. This may be useful for illuminating square or rectangular areas. The second beam shaping elements 1222 may provide an essentially rotational symmetric beam, whereas the total internal reflection beam shaping elements 220 may provide a slightly distorted rotational symmetric beam shape. The shape as schematically shown in cross-section in FIG. 3f implies that a (virtual) line connecting the optical axis and the face(s) may have different lengths (at the same height), when at different positions at the face(s) (at the same height).

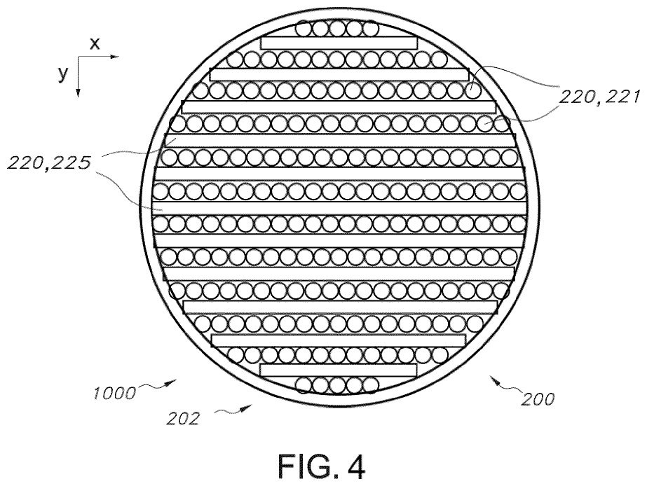

FIG. 4 shows an interdigitated light transmissive optics arrangement 200 comprising an array 202 of parallel arranged prisms 225 and regularly arranged conical-like or pyramidal-like shapes with tops 221 as the internal reflection beam shaping elements 220 of a lighting system 1000. A fraction of about ⅓ of the surface area covered by internal reflection beam shaping elements 220 is covered by prisms 225 and about ⅔ of said surface area is covered by the conical-like or pyramidal-like shapes 221. The prisms 225 split the collimated light source light in the y-direction to typically provide a batwing light distribution while the round cones 221 diverge provide the collimated light source light both in the x- and y-direction to provide a circular ring-shaped light distribution in the x-y field.

Hence, in embodiments the invention provides a lighting system having an optical axis and comprising at least one light source for issuing source light into one or more collimators from a respective focal point of each collimator from the one or more of collimators. Especially, the collimators redirect at least a part of said source light as collimated light downstream towards a transversely extending, transparent beam shaping element. Further, especially the beam shaping element has on a main surface a (pseudo) randomized pattern of micro-sized cone-shaped TIR optical elements for generating a desired batwing beam profile. The light source may especially comprise at least one LED.

The light source can be positioned behind a plate with small openings in a plate (a 1a WO2017182370A1) illuminated by a light source. The light source can be positioned in a focal point at the bottom of a (parabolic reflector). The light source can be positioned in the focal point at an exit window of the collimator and facing upstream.

The collimators can be parabolic (TIR-) reflector, (TIR-) Fresnel plate. The collimated light especially propagates along the optical axis to imping perpendicular onto the beam shaping element.

The beam shaping elements, such as cone-shaped (T)IR optical elements especially extend along the optical axis. Further, they are especially micro-sized. Further, the beam shaping elements may be provided as (pseudo) randomized pattern extending as one integral pattern over the plurality of collimators (hence, in embodiments no (pseudo) randomized pattern per collimator). Especially, a pseudo randomized pattern such as a phyllotaxis pattern is selected.

The term “plurality” refers to two or more.

The term “substantially” herein, such as in “substantially all light” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention also provides a control system that may control the apparatus or device or system, or that may execute the herein described method or process. Yet further, the invention also provides a computer program product, when running on a computer which is functionally coupled to or comprised by the apparatus or device or system, controls one or more controllable elements of such apparatus or device or system.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A lighting system comprising n lighting devices, wherein each lighting device comprises a light source configured to generate light source light and at least one collimating beam shaping element configured to collimate the light source light into collimated light source light, in total m collimating beam shaping elements, and a light transmissive optics arrangement comprising an array of k total internal reflection beam shaping elements, configured downstream of the m collimating beam shaping elements, wherein the light transmissive optics arrangement is configured to receive the collimated light source light and to transform into a divergent beam of lighting system light, wherein n≥1, m≥n, and k≥3*m, and wherein at least 25% of the total internal reflection beam shaping elements have a conical-like or pyramidal-like shape with tops
wherein the lighting system comprises at least two types of differently sized beam shaping elements, wherein first beam shaping elements comprise the total internal reflection beam shaping elements, and wherein sets of three or more first beam shaping elements surround one second beam shaping element.

2. The lighting system according to claim 1, wherein the light source comprises a solid state light source, and wherein each collimating beam shaping element comprises one or more of a collimator, a TIR collimator, a concave reflector, a refractive lens, and a Fresnel lens, and wherein the light transmissive optics arrangement comprises one or more of polymethyl methacrylate and polycarbonate total internal reflection beam shaping elements.

3. The lighting system according to claim 1, wherein essentially all the total internal reflection beam shaping elements have a conical-like or pyramidal-like shape with tops.

4. The lighting system according to claim 3, wherein each top has a full top angle selected from the range of 57.5-75°.

5. The lighting system according to claim 1, wherein the total internal reflection beam shaping elements have one or more dimensions selected from the group consisting of a base width, a base length, a base diameter, and an element height, wherein one or more of these dimensions are selected from the range of 0.02-10 mm.

6. The lighting system according to claim 5, wherein k≥9*m, and wherein the one or more of these dimensions are selected from the range of 1-6 mm.

7. The lighting system according to claim 1, comprising a plurality of n lighting devices configured in an array, wherein n≥4 and m=n, and wherein one or more light sources of the plurality of n lighting devices comprise a plurality of solid state light sources.

8. The lighting system according to claim 7, wherein the beam shaping elements, have a base and an apex and taper in a direction from the base to the apex, and wherein the tapering is symmetrical for a sub-group of the beam shaping elements.

9. The lighting system according to claim 1, wherein the array of total internal reflection beam shaping elements comprises a random or pseudo-random arrangement of the total internal reflection beam shaping elements.

10. The lighting system according to claim 9, wherein the array of total internal reflection beam shaping elements comprises phyllotaxis arrangement of the total internal reflection beam shaping elements.

11. The lighting system according to claim 1, wherein the lighting system is configured to generate a batwing shaped beam of lighting system light.

12. The lighting system according to claim 1, wherein the lighting system is configured to generate the beam of lighting system light with an optical axis, wherein at least 50% of a total intensity of the lighting system light is at an angle of at least 50° relative to the optical axis.

13. A lamp comprising the lighting system according to claim 1.

14. The lamp according to claim 13, wherein the lamp is an outdoor lamp.

15. A method of illuminating an area selected from the group of an outdoor open area, a square, a road, and a plant area, the method comprising providing lighting system light with the lighting system according to claim 1.
